(19) United States
(12) Patent Application Publication
(10) Pub. No.: US 2015/0381090 A1
(43) Pub. Date: Dec. 31, 2015

(54) SENSORLESS SYSTEM AND METHOD FOR DETERMINING MOTOR ANGLE AT ZERO OR LOW SPEEDS

(71) Applicant: NIDEC MOTOR CORPORATION, St. Louis, MO (US)

(72) Inventors: Michael I. Henderson, North Yorkshire (GB); Joseph G. Marcinkiewicz, St. Peters, MO (US)

(73) Assignee: NIDEC MOTOR CORPORATION, St. Louis, MO (US)

(21) Appl. No.: 14/750,968

(22) Filed: Jun. 25, 2015

Related U.S. Application Data
(60) Provisional application No. 62/017,673, filed on Jun. 26, 2014.
(60) Provisional application No. 62/017,669, filed on Jun. 26, 2014.

(51) Int. Cl. H02P 21/13; H02P 21/04

(52) U.S. Cl. CPC H02P 21/13; H02P 21/04

(57) ABSTRACT

A system and method for determining electrical angles of electric motors at zero and low speeds without using angle sensors, and a system and method for estimating resistances and temperatures in electric motors, wherein the two systems and methods may be used separately or together. When used together, they substantially simultaneously estimate motor flux linkage, magnet flux, and motor resistance. In particular, the estimated magnet flux is used to derive the electrical angle and to estimate an average rotor temperature, and the estimated motor resistance is used to estimate the average stator temperature. A Kalman filter, which may be a linear Kalman filter or a Luenberger observer, is used to update state equations from which various motor parameters can be derived or estimated. The system and method which works for motors operating at zero and low speeds can be combined with systems and methods that work at high speeds.

### RELATED APPLICATIONS

The present non-provisional patent application claims priority benefit with regard to all common subject matter of U.S. provisional patent application titled SENSORLESS SYSTEM FOR DETERMINING MOTOR ANGLE AT ZERO OR LOW SPEEDS, Ser. No. 62/017,673, filed Jun. 26, 2014, and U.S. provisional patent application titled MOTOR TEMPERATURE ESTIMATION SYSTEM, Ser. No. 62/017,669, filed Jun. 26, 2014. These prior-filed provisional patent applications are hereby incorporated by reference into the present non-provisional patent application as if set forth in their entireties.

### FIELD

The present invention relates to systems and methods for controlling the operation of electric motors, and, more particularly, to a system and method for determining electrical angles of electric motors at zero and low speeds without using angle sensors.

### BACKGROUND

It may be desirable to determine the electrical angles of electric motors during operation. One method for determining such electrical angles during high speed operation without using sensors involves a set of state equations relating flux to applied voltage, and derives electrical angle, speed, and other motor parameters. Under this approach, it is possible to accommodate the effect of motor saturation, it is not necessary to include an approximate model of motor torque and the driven system in the equations used by the sensorless process, and the state equations are linear in the motor variables. Consequently, a Luenberger observer or a linear Kalman filter can be used, and this greatly reduces computational complexity. Saturation is accommodated by the implementation of the bulk current model for inductance. This approach uses a measure of the total current present in the motor in a function which gives the value of motor inductance at that operating point. As this value changes relatively slowly compared to the filter or observer dynamics, the dynamics of the process and how it impacts the sensorless scheme can be ignored. However, at zero and low speeds, the variation in terminal variables (current and voltage) as a result of the motor rotating may be small. Consequently, there may be too little available information from which to determine electrical angle and speed.

It may also be desirable to determine the resistances and the temperatures of electric motors. Systems in which a motor drive is mounted to the motor may allow for direct measurement of the motor's temperature. Systems in which the motor drive is not in direct contact with the motor may not allow for such direct measurement and, instead, may require that wires be run between the motor drive and the motor or that the temperature of the motor be estimated or inferred using motor variables which are available to software resident on the drive. In a sensorless system, the available motor variables may be the motor phase currents and voltages. Changing winding resistance may provide a measure of motor health and an indication of stator temperature. However, estimating resistance while operating sensorlessly is not trivial. Uncertainty as to electrical angle may make it difficult to estimate resistance if carried out in a second estimator, and can lead to erroneous results, such as negative resistance. Furthermore, manufacturing variance may result in variations in the motor resistance at nominal temperature. If the nominal resistance is assumed for every motor, then the estimated temperatures of the stator and rotor may be higher or lower than the actual temperatures. Additionally, motor resistance may change as the load increases, which is a result of additional inverter and motor losses. Typical mechanisms producing this effect include inverter switch losses and alternating current copper losses resulting from skin effects within the motor.

This background discussion is intended to provide information related to the present invention which is not necessarily prior art.

### SUMMARY

Embodiments of the present invention solve the above-described and other problems and limitations by providing a system and method for determining electrical angles of electric motors at zero and low speeds without using angle sensors, and a system and method for estimating resistances and temperatures in electric motors, wherein the two systems and methods may be used separately or together. When used together, they may substantially simultaneously estimate motor flux linkage, magnet flux, and motor resistance. In particular, the estimated magnet flux may be used to derive the electrical angle and to estimate an average rotor temperature, and the estimated motor resistance may be used to estimate the average stator temperature.

In a first embodiment of the present invention, a system is provided for determining an electrical angle of an electric motor operating at zero or low speed, wherein the electric motor is characterized by one or more state equations. The system may comprise the electric motor, an inverter, and a control element. The inverter may be configured to drive the electric motor with a control signal. The control element may be configured to perform the following steps. The control element may inject a high frequency voltage demand into the control signal. The control element may read a motor current and a motor voltage in a stationary reference frame, and then transform the motor current and the motor voltage into a diagnostic reference frame. The control element may determine a bulk current model for a motor inductance and a motor resistance. The control element may update the one or more state equations using a Kalman filter, and then determine the electrical angle using the updated one or more state equations.

In a second embodiment, a method is provided for determining an electrical angle of an electric motor operating at zero or low speed, wherein the electric motor is driven by an inverter and characterized by one or more state equations. The method may include the following steps. A high frequency voltage demand may be injected into a control signal for the inverter. A motor current and a motor voltage may be read in a stationary reference frame, and then the current and the motor voltage may be transformed into a diagnostic reference frame. A bulk current model may be determined for a motor inductance and a motor resistance. The one or more state equations may be updated using a Kalman filter, and then the electrical angle may be determined using the updated one or more state equations.

Various implementations of the foregoing embodiments may include any one or more of the following additional features. The electric motor may be a three phase, balanced fed permanent magnet electric motor that drives a load. By way of non-limiting example, the load may be a fan, a pump, a blower, a rotating drum, a component of a clothes washer or clothes dryer, a component of an oven, a component of a heating and air-conditioning unit, or a component of a residential or commercial machine. The electric motor may be operating at a speed that is equal to or less than approximately between 200 and 300 mechanical revolutions per minute. The stationary reference frame may be an abc reference frame or an alpha-beta reference frame. The Kalman filter may be a linear Kalman filter or a Luenberger observer. The control element may further perform, or the method may further include, the steps of estimating an electrical speed of the electric motor as a differential of the electrical angle, and filtering the electrical speed using a first order filter.

This summary is not intended to identify essential features of the present invention, and is not intended to be used to limit the scope of the claims. These and other aspects of the present invention are described below in greater detail.

### DRAWINGS

Embodiments of the present invention are described in detail below with reference to the attached drawing figures, wherein:

FIG. 1 is a cutaway depiction of an embodiment of a sensorless system of the present invention for determining electrical angle at zero or low speeds, resistance, and temperature values for an electric motor;

FIG. 2 is a flow chart of steps in an embodiment of a sensorless method for determining electrical angles of electric motors at zero and low speeds, wherein the method may be performed by the system of FIG. 1; and

FIG. 3 is flowchart of steps in an embodiment of a method for estimating resistances and temperatures of electric motors, wherein the method may be performed by the system of FIG. 1.

The figures are not intended to limit the present invention to the specific embodiments they depict. The drawings are not necessarily to scale.

### DETAILED DESCRIPTION

The following detailed description of embodiments of the invention references the accompanying figures. The embodiments are intended to describe aspects of the invention in sufficient detail to enable those with ordinary skill in the art to practice the invention. Other embodiments may be utilized and changes may be made without departing from the scope of the claims. The following description is, therefore, not limiting. The scope of the present invention is defined only by the appended claims, along with the full scope of equivalents to which such claims are entitled.

In this description, references to “one embodiment”, “an embodiment”, or “embodiments” mean that the feature or features referred to are included in at least one embodiment of the invention. Separate references to “one embodiment”, “an embodiment”, or “embodiments” in this description do not necessarily refer to the same embodiment and are not mutually exclusive unless so stated. Specifically, a feature, structure, act, etc. described in one embodiment may also be included in other embodiments, but is not necessarily included. Thus, particular implementations of the present invention can include a variety of combinations and/or integrations of the embodiments described herein.

Broadly characterized, the present invention provides both a system and method for determining electrical angles of electric motors at zero and low speeds without using angle sensors, and a system and method for estimating resistances and temperatures in electric motors, wherein the two systems and methods may be used separately or together. When used together, they may substantially simultaneously estimate motor flux linkage, magnet flux, and motor resistance. In particular, the estimated magnet flux may be used to derive the electrical angle and to estimate an average rotor temperature, and the estimated motor resistance may be used to estimate the average stator temperature.

As used herein, zero or low speed may be equal to or less than approximately between 200 and 300 mechanical revolutions of the motor rotor per minute. This signal may be added to a signal is sent to the inverter demand. “Flux linkage” may refer to the total flux across the rotor and stator poles, of which one component is the magnet flux. The present invention may estimate flux linkage and magnetic flux using a Kalman filter or a Luenberger observer. In various implementations, the present invention may use substantially any suitable filter, such as such as a linear or extended Kalman filter, an unscented Kalman filter, a Luenberger observer, or an HInfinity filter, among others. These values may then be used to infer the current flowing in the phase windings, and this may then be compared to the actual and measurable current flowing in the windings. The error between the inferred values and the measured values, together with knowledge of the applied voltage, may then be used to update the next estimate of the motor states which may be unavailable for direct measurement. “Motor states” may refer to the flux linkage and magnet flux values. These states may be transformed into the drive frame of reference when considering the high speed problem together with resistance estimation, or may be transformed into the diagnostic reference frame when considering the zero speed problem. In the former case the four states may be augmented by the resistance parameter, while in the latter case they may be augmented by two auxiliary state vectors.

For some systems, current may be measurable and voltage may be either measurable or inferable, but electrical angle, speed, and flux may not be known. Furthermore, resistance and inductance may be generally known but may change due to, e.g., manufacturing variances and motor heating. Values measured at the motor terminals, such as motor phase voltage or current, may be in the abc-reference frame, which is stationary. More particularly, the electrical variables in the motor may be represented in equations which make use of terminal measurable values (abc) or, in a rotating reference frame, an angle. This angle may be defined by the electrical frame (identified by the subscript Qdr in the exemplary supporting equations set forth below). In one embodiment of the present invention, the demanded electrical speed (identified by the subscript Qdv) may be used. The use of quasi-stationary (near dc-values) means that the dynamics of the filter or observer need not closely match the system, which allows for easier design and implementation of the system. Although in a sensorless system the electrical angle may not be known, a rotating reference frame defined by the demanded speed may be defined and the motor state equations defined with respect to this alternative frame of reference.

The system and method of the present invention which works for motors operating at zero and low speeds may be combined with systems and methods that work for motors operating at high speeds. In various implementations, this may be accomplished by creating a single augmented set of state equations, or defining a single variable speed rotating reference frame scheme in which the frame angle varies as the motor transitions from low to high speeds, or switching from zero or low speed to high speed as needed.

System Components

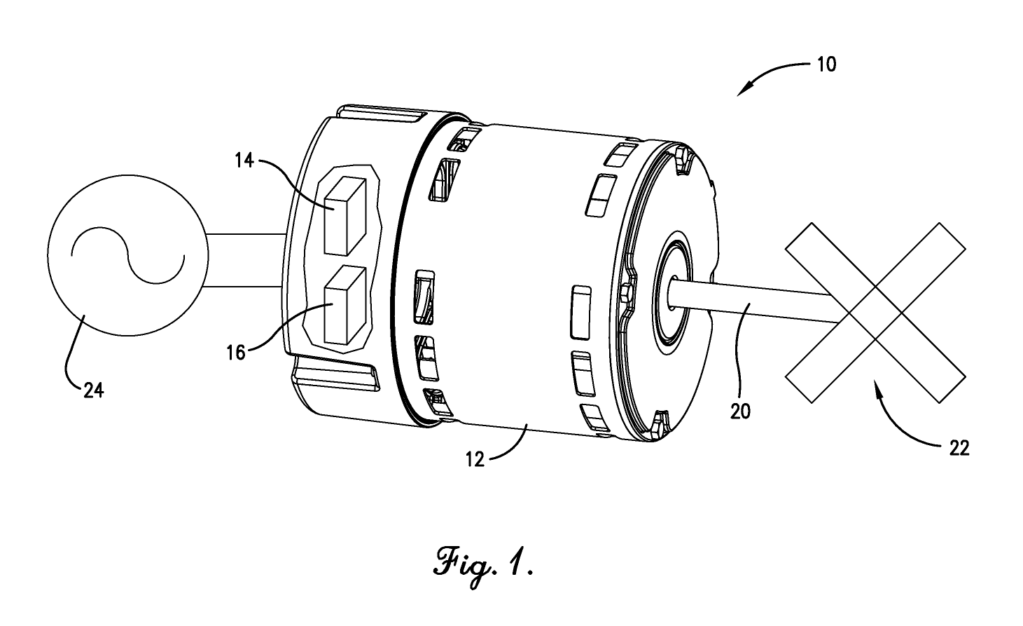

In one embodiment, the present invention concerns a system for determining an electrical angle for an electric motor at zero and low speeds without using a sensor and/or for estimating a resistance and a temperature for the electric motor. Referring to FIG. 1, the system 10 may broadly include an electric motor 12; an inverter 14; and a control element 16. The electric motor 12 may be a three phase, balanced fed permanent magnet electric motor. The electric motor 12 may include a shaft 20 to facilitate driving any appropriate load 22. By way of non-limiting example, the load 22 may be a fan, a pump, a blower, a rotating drum, a component of a clothes washer or clothes dryer, a component of an oven, a component of a heating and air-conditioning unit, and a component of a residential or commercial machine. In another non-limiting example, the system and/or method of the present invention may be employed in automotive applications, such as in a traction motor or generator or starter generator. In particular, the present invention's ability to track BEMF under manufacturing variance and thermal change may allow for more accurately estimating motor torque in certain these circumstances. The inverter 14 may be configured to receive alternating current (AC) power from an AC power source 24, and may condition the AC power to produce a control signal for driving the electric motor 12.

In one embodiment, the control element 18 may be configured to perform the following steps. The control element 18 may inject a high frequency voltage demand into the control signal produced by the inverter 14. More specifically, for zero speed sensorless operation an additional excitation signal, typically a “high frequency” sinusoidal signal of relatively low amplitude, may be injected. In general, for high speed operation this additional excitation signal may not be needed; however, it may be needed even during high speed operation when estimating motor resistance and temperature. Thus, an additional excitation signal may be injected both when determining an electrical angle for an electric motor at zero and low speeds without using a sensor and when estimating a resistance and a temperature for the electric motor, even at high speeds.

In another embodiment, the control element 18 may be additionally or alternatively configured to perform the following steps as part of the process for determining the resistance and the temperature of the electric motor 12. The control element 18 may inject a high frequency voltage demand into the control signal produced by the inverter 14. The control element 18 may read a motor current and a motor voltage in a stationary reference frame, and then transform the motor current and the motor voltage into a diagnostic reference frame. The control element 18 may determine a bulk current model for a motor inductance and a motor resistance. The control element 18 may update the one or more state equations using a Kalman filter, transform a magnet flux back into the stationary reference frame, and then determine an electrical angle based on the magnet flux. The control element 18 may determine an estimated motor resistance, and then determine a stator temperature using the estimated motor resistance. The control element 18 may determine a back electromotive force constant using the estimated magnet flux, and then determine a rotor temperature based on a change in the back electromotive force constant.

In various implementations of either or both of these embodiments, the control element 18 may read a motor current and a motor voltage in a stationary reference frame, which may be an abc reference frame or an alpha-beta reference frame, and then transform the motor current and the motor voltage into a diagnostic reference frame. The control element 18 may determine a bulk current model for a motor inductance and a motor resistance. The control element 18 may update the one or more state equations using a Kalman filter, which may be a linear Kalman filter or a Luenberger observer, and then determine the electrical angle using the updated one or more state equations. The electric motor 12 may be operating at a zero or low speed that is equal to or less than approximately between 200 and 300 mechanical revolutions per minute. The control element 18 may also estimate an electrical speed of the electric motor 12 as a differential of the electrical angle, and filter the electrical speed using a first order filter. The system 10, and particularly the control element 18, may be further configured to implement additional features set forth in the following discussions of the method of determining electrical angles of electric motors at zero and low speeds and the method of estimating resistances and temperatures of electric motors.

Determining Electrical Angles of Electric Motors at Zero and Low Speeds

In one embodiment, the present invention concerns a method for determining an electrical angle of an electric motor at zero and low speeds without using a sensor. The electric motor may be a three phase, balanced fed permanent magnet electric motor. Broadly, the scheme may be based on the presence of angle-varying inductance within the motor. In one implementation, the scheme may accommodate the presence of harmonics within the back electromotive force (BEMF), typically x5 and x7 electrical angle harmonics.

At zero and low speed, the variation in terminal variables (current and voltage) as a result of the motor rotating may be small. Consequently, there may be too little available information from which to determine electrical angle and speed. Thus, at zero or low speed, high speed diagnostic signals may be injected into the stator windings to artificially create variations in the motor terminal variables. These high speed signals may be voltages applied to the stator winding in addition to any demanded voltage from the motor control system. At zero speed, little or no attempt may be made to control the motor until the process of estimating the electrical angle has locked on to a meaningful value. Subsequently, a controlling value can be applied to the motor. Following this order may avoid the onset of chaotic motor input and output which could confuse the sensorless scheme.

In one embodiment, the sensorless method of the present invention may be based on state variables which are defined in a rotating reference frame, the drive reference frame, Qdᵥ. This provides significant advantages with regard to the convergence dynamics of a linear Kalman filter or a Luenberger observer. It also avoids involving estimated motor torque and inertia, which provides significant advantages over methods that use such variables.

The rotating reference frame may be defined by the demanded speed. This may produce pseudo-stationary signals (in practice, low frequency sinusoidal signals) that may be useful in defining and operating the sensorless scheme. However, at zero speed a new rotating reference frame, the diagnostic reference frame, may be defined. This reference frame rotates at the speed defined by the diagnostic signals. For example, if a two hundred hertz (200 Hz) sinusoidal signal is injected into the stator windings, then the reference frame rotates at approximately 20 radians per second.

Variations in motor current and voltage may occur around the same frequency as the injected signal. Transforming these signals from the stationary to the diagnostic reference frame converts a relatively high speed AC signal into a pseudo-stationary or relatively slowly varying signal. Changes in the motor electrical angle and speed are connected to the slowly varying dc-component of the transformed signal. This facilitates the estimation process locking on to the signal and picking out the required information. To some extent, the dynamics of the system are decoupled from the filter or observer, which facilitates designing and implementing the algorithm.

The equations describing the electrical behavior may be transformed into the diagnostic reference frame. In one implementation, the electrical reference frame may be transformed to the diagnostic reference frame. The result of this process may be a set of equations which are linear combinations of transformed motor states and not involving any non-linear terms. This allows for implementing the sensorless scheme using the Luenberger observer of the linear Kalman filter. The linear Kalman filter may be implemented using fixed gains, which may greatly reduce the computational overhead.

In practice, the transform of the state equations into the diagnostic reference frame may almost achieve this goal. A simplification in the equations may facilitate achieving the goal through auxiliary state variables. This simplification, combined with the properties of the filter or observer, allow for overcoming the estimation problem.

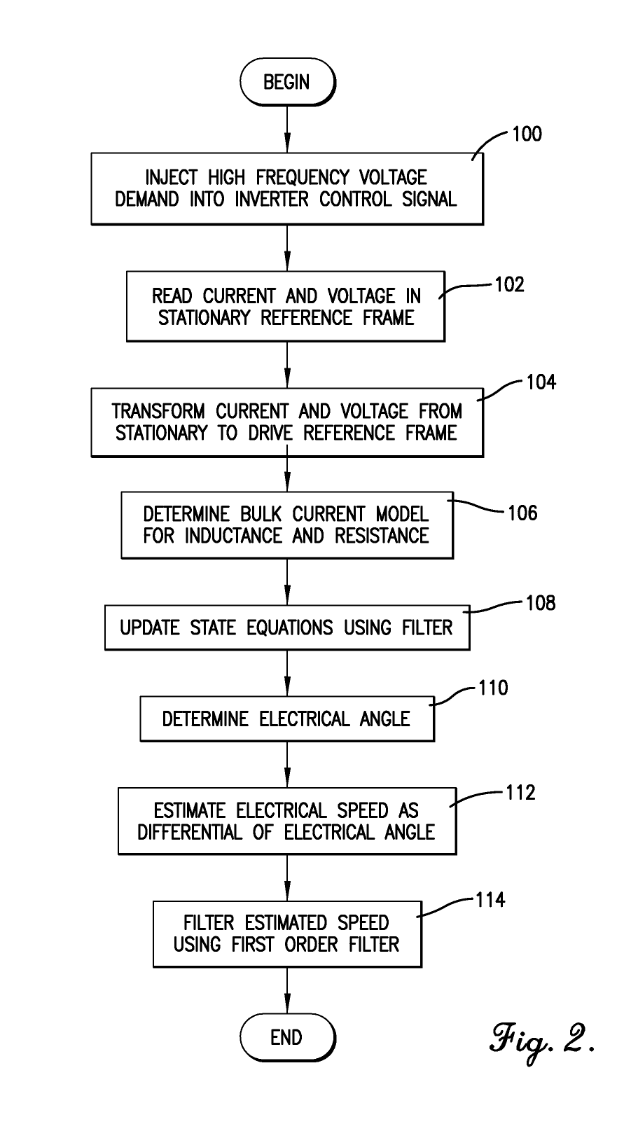

Referring to FIG. 2, an embodiment of the method for determining electrical angles of electric motors at zero and low speeds may broadly comprise some or all of the following steps. By way of example, the method may be used on a three phase, permanent magnet electric motor with a standard inverter, and the motor may be characterized by one or more state equations. While running in a zero or low speed mode, a high frequency voltage demand may be injected into a control signal produced by an inverter, as shown in step 100. A current and a voltage may be read in a stationary reference frame, such as an abc reference frame or an alpha-beta reference frame, as shown in step 102. The current and the voltage read in the stationary reference frame may be transformed into a diagnostic reference frame, as shown in step 104. A bulk current model for an inductance and a resistance may be determined, as shown in step 106. The one or more state equations may be updated using a linear Kalman filter or a Luenberger observer, as shown in step 108. An electrical angle of the electric motor may be determined based on the updated one or more state equations, as shown in step 110.

In one implementation, the method may further include estimating an electrical speed of the electric motor as a differential of the electrical angle, as shown in step 112, and filtering the estimated electrical speed using a first order filter, as shown in step 114. This may isolate the dynamics of speed estimation and filter operation.

Further discussion as well as exemplary mathematical expressions supporting one or more of the foregoing concepts are set forth below. It will be appreciated that some of these concepts may be expressed using alternative mathematical expressions without departing from the contemplated scope of the claimed invention.

Estimating Resistances and Temperatures of Electric Motors

In one embodiment, the present invention concerns a method for estimating a resistance and a temperature of an electric motor. The electric motor may be a three phase, balanced fed permanent magnet electric motor. Broadly, the method may involve estimating a motor resistance and a magnet constant. Consequentially, there may be two temperature estimates, one for the stator and the other for the rotor. The impact of loss mechanisms on nominal motor resistance may be accommodated in a manner similar to how inductance is accommodated. More particularly, a bulk current model for phase resistance may be defined and the parameters estimated from data gathered at various motor running points.

It may be desirable to estimate motor resistance during operation because changing winding resistance may provide a measure of motor health and an indication of stator temperature. Additionally, the resistance value may be used to improve the operation of the system and method for determining angles at zero and low speeds. More particularly, estimating resistance while operating sensorlessly is not trivial. However, combining the electrical angle and resistance estimation processes can ameliorate some of the issues. In particular, the state equations defined in the rotating reference frame given by demanded speed may be used, with resistance being explicitly estimated together with motor flux. Thus, system states and parameters may be simultaneously estimated.

In one embodiment, motor resistance may be modelled as a constant plus a Gaussian white noise signal of appropriate variance. The order of magnitude of the variance may be implied by the expected maximum rate of change in the resistance. Over time, the filter may accept or reject changes in the resistance parameter, so this value may track changes in the system. With increasing torque motor load, both the applied voltage and the current flow may increase. Various effects (operation of power electronics, skin effects on motor windings) may give the appearance of increased motor resistance even without a change in motor winding resistance. In the present invention, these effects may be separately modeled by defining, in a manner similar to that used to create the bulk current inductance model, a bulk current model for resistance. Thus, the present invention may distinguish temperature induced increases in resistance from apparent increases in motor resistance due to motor winding skin effects or motor inverter power electronics effects.

In one embodiment, knowledge of all three phase currents may be assumed, while in other embodiments, it may not be. The sensorless scheme may be used to estimate phase currents for which no sensor measurement is available. This situation may occur when a motor phase current sensor fails or when motor phase currents are reconstructed from a single dc-link current sensor in combination with knowledge of switching in the power electronics. In the latter case, there may be occasions when only one out of three currents can be reconstructed. Using the sensorless scheme, the missing two phase currents may be estimated and then used in the controller. This option may be useful for operating a motor in sensorless six-step.

A Kalman filter may be used to implement the scheme, and the scheme may be simplified using standard methods to reduce its computational complexity and cost. The temperature estimation scheme may use knowledge of the motor phase resistance at a given temperature. Changes in this starting resistance may then imply changes in motor resistance through the resistivity equation. However, overly large manufacturing variance may make it desirable to track absolute resistance values.

While attempting to estimate resistance it may be desirable to inject excitation signals into the motor. These may or may not be the same as the high frequency signal injection used for the zero or low speed sensorless method. When estimating motor parameters (for example resistance or inductance) as opposed to motor states (current or flux flow) it may be desirable to inject some additional excitation signal into the motor in order to aid the estimation process. These additional signals may be designed so as to avoid generating additional noise or variations in motor speed.

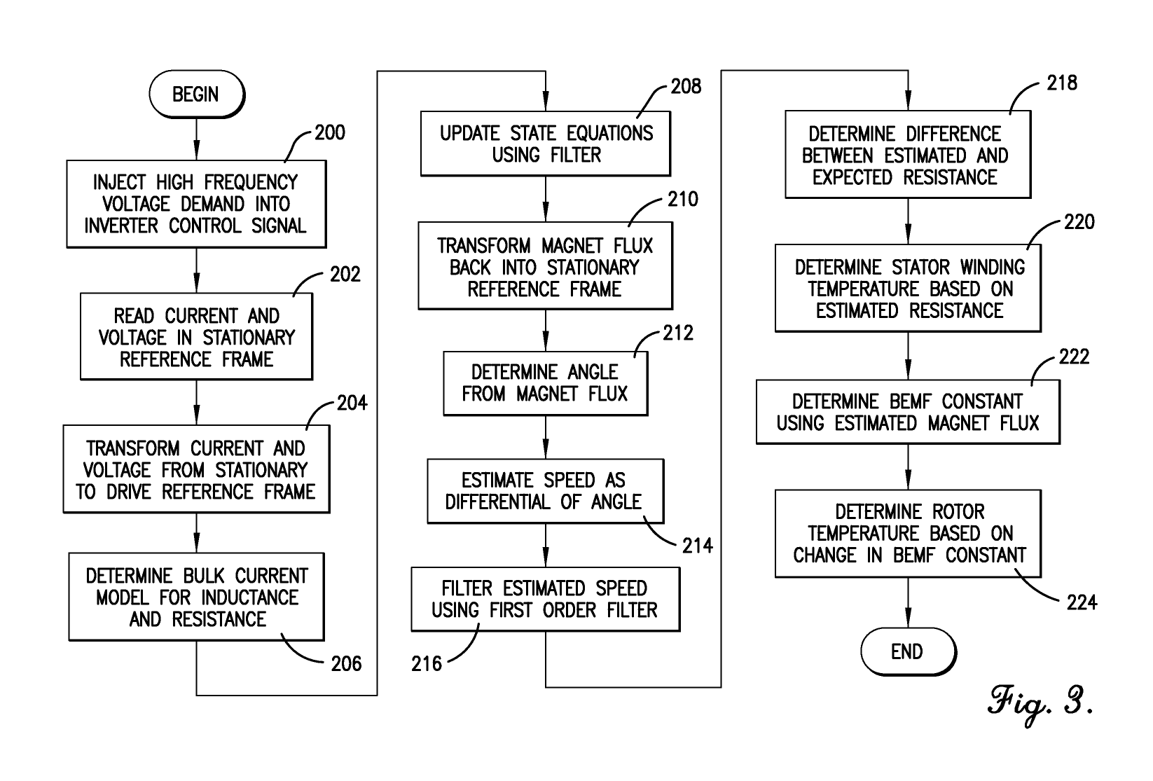

Referring to FIG. 3, an embodiment of the method of estimating resistances and temperatures of electric motors may broadly comprise some or all of the following steps. By way of example, the method may be used on a three phase, permanent magnet electric motor with a standard inverter, and the motor may be characterized by one or more state equations. A frequency voltage demand may be injected into a control signal produced by an inverter, as shown in step 200. A current and a voltage may be read in a stationary reference frame, such may be an abc reference frame or an alpha-beta reference frame, as shown in step 202. The current and the voltage read in the stationary reference frame may be transformed into a diagnostic reference frame, as shown in step 204. A bulk current model for an inductance and a resistance may be determined, as shown in step 206. The one or more state equations may be updated using a linear Kalman filter or a Luenberger observer, as shown in step 208.

A motor magnet flux may be transformed back into the stationary reference frame, as shown in step 210. The electrical angle may be determined from the magnet flux, as shown in step 212. In one implementation, the speed may be estimated as a differential of the electrical angle, as shown in step 214, and the estimated speed may be filtered using a first order filter, as shown in step 216. This may isolate the dynamics of speed estimation and filter operation. A difference between an expected resistance (from the bulk current model) and an estimated resistance may be determined, as shown in step 218. An average stator winding temperature may be calculated using the estimated motor resistance, as shown in step 220. A BEMF constant may be determined using the estimated magnet flux, as set forth in step 222. A rotor temperature may be determined based on a change in the BEMF constant, as shown in step 224.

Based on analyzing the variable states within the filter, the system may be able to determine when it has arrived at a reasonably accurate estimate of resistance. When this occurs, the estimation process may be switched off and the injection of any additional system excitation may be stopped. The estimation process and injection of excitation may be resumed if filter errors (between measured and estimated states) begin to grow.

Further discussion as well as exemplary mathematical expressions supporting one or more of the foregoing concepts are set forth below. It will be appreciated that some of these concepts may be expressed using alternative mathematical expressions without departing from the contemplated scope of the claimed invention.

Further Discussion and Exemplary Mathematical Expressions

An embodiment of the present invention may transform the motor electrical equations from a stationary reference frame (abc or αβ frames of reference) into the drive reference frame, which may be defined by the demanded speed. For the system and method of estimating electrical angles at zero and low speeds, these electrical equations may be transformed into a rotating reference frame which may be defined by a diagnostic frequency, which may also define an excitation signal injected into the stator windings. Such a transform may result in a set of state equations which may also contain additional or auxiliary state variables. In particular, a set of first order linear differential equations may be produced with constant coefficients which may be suitable for implementation using either a Kalman filter or a Luenberger observer.

A diagnostic signal may be injected into the motor stator windings. This signal may be a sinusoidal voltage with a relatively high frequency in the hundreds of hertz, and may be added to the control signal being passed into the inverter.

When the machine state variables are transformed into the diagnostic reference frame, a quasi-stationary signal may be produced. This may be similar to that for the high speed scheme defined in the drive frame of reference, but in this case, the low frequency variation in machine states may be due to motion in the rotor and not to the difference between drive and electrical speeds. Using the diagnostic reference frame state equations in combination with the Kalman filter or Luenberger observer allows for estimating motor flux, and from these states the electrical angle may be inferred.

The zero and low speed scheme may be implemented in conjunction with a high speed scheme. In one embodiment, the schemes may be implemented separately, and a state machine may be defined to switch from one to the other depending on state values. In another embodiment, an augmented state observer may be used in which both schemes are present, effectively stacking one set of state equations on top of the second set of state equations. In this approach, the diagnostic signals may simply be injected or faded out in value depending on how well the high speed sensorless scheme estimates angle. There may be no associated state machine, and the presence of a diagnostic signal may be defined as a function of filter covariance and motor rotor speed. In yet another embodiment, a set of state equations may be defined and an arbitrary reference frame may be defined by some speed. With lost rotor (initial startup) or low speed, this may be defined by the diagnostic angle but may transition into the demanded angle as the angle estimate locks or converges on an actual value.

In one embodiment of the present invention, the following basic definitions may be used.

Unit vectors:

$${U}_{x} = [ \begin{matrix}1 \\ 0\end{matrix} ]$$

$${U}_{y} = [ \begin{matrix}0 \\ 1\end{matrix} ]$$

### Rotation:

$$G = [ \begin{matrix}0 & 1 \\ - 1 & 0\end{matrix} ]$$

abc to aβ transform:

$$C = [ \begin{matrix}2 \text{/} 3 & - 1 \text{/} 3 & - 1 \text{/} 3 \\ 0 & - 1 \text{/} \sqrt{3} & 1 \text{/} \sqrt{3}\end{matrix} ]$$

αβ transform to a rotating reference frame defined by angle θ:

$$K ( θ ) = [ \begin{matrix}cos ( θ ) & - sin ( θ ) \\ sin ( θ ) & cos ( θ )\end{matrix} ]$$

Currents in the electrical reference frame:

$${I}_{Qdr} = [ \begin{matrix}{I}_{Qr} \\ {I}_{dr}\end{matrix} ]$$

Volts in the electrical reference frame:

$${V}_{Qdr} = [ \begin{matrix}{V}_{Qr} \\ {V}_{dr}\end{matrix} ]$$

Electrical speed:

ωᵣ

Electrical reference frame resistance in Qr and dr axis:

R_{Qr}, R_{dr}

Electrical reference frame resistance matrix:

$${R}_{Qdr} = [ \begin{matrix}{R}_{Qr} & 0 \\ 0 & {R}_{dr}\end{matrix} ]$$

The diagonal form of the matrix may assume that all phase resistances are equal:

R_{Qr}=R_{dr}=R_{Qdr}

Self and mutual phase inductance in the terminal frame of reference may be expressed by:

L, M

It may be assumed that:

$$M = \frac{L}{2}$$

C and V subscripts may be used to indicate inductance components which are constant of (C) and vary with (V) rotor angle.
The abc frame of reference constant inductance matrix may be expressed as:

$${L}_{Cabc} = [ \begin{matrix}L & - M & - M \\ - M & L & - M \\ - M & - M & L\end{matrix} ]$$

The αβ frame of reference constant inductance matrix may be expressed as:

$${L}_{C αβ} = [ \begin{matrix}L + M & 0 \\ 0 & L + M\end{matrix} ]$$

The Qdr (electrical) frame of reference constant inductance matrix may be expressed as:

$${L}_{CQdr} = [ \begin{matrix}L + M & 0 \\ 0 & L + M\end{matrix} ]$$

The angle varying inductance matrix in the motor terminal frame of reference may be expressed as:

$${L}_{Vabc} = [ \begin{matrix}- {L}_{V} \cdot cos ( 2 \cdot {θ}_{r} ) & - {L}_{V} \cdot cos [ 2 \cdot ( {θ}_{r} - π \text{/} 3 ) ] & - {L}_{V} \cdot cos [ 2 \cdot ( {θ}_{r} + π \text{/} 3 ) ] \\ - {L}_{V} \cdot cos [ 2 \cdot ( {θ}_{r} - π \text{/} 3 ) ] & - {L}_{V} \cdot cos [ 2 \cdot ( {θ}_{r} - 2 \cdot π \text{/} 3 ) ] & - {L}_{V} \cdot cos [ 2 \cdot ( {θ}_{r} + π ) ] \\ - {L}_{V} \cdot cos [ 2 \cdot ( {θ}_{r} + π \text{/} 3 ) ] & - {L}_{V} \cdot cos [ 2 \cdot ( {θ}_{r} + π ) ] & - {L}_{V} \cdot cos [ 2 \cdot ( {θ}_{r} + 2 \cdot π \text{/} 3 ) ]\end{matrix} ]$$

In the alpha-beta reference frame:

$${L}_{V αβ} = {C}_{3 \times 3} \cdot {L}_{Vabc} \cdot {C}_{3 \times 3}^{- 1}$$

$${L}_{V αβ} = [ \begin{matrix}\frac{3 \cdot {L}_{V} \cdot cos ( 2 \cdot {θ}_{r} )}{2} & \frac{3 \cdot {L}_{V} \cdot sin ( 2 \cdot {θ}_{r} )}{2} & 0 \\ \frac{3 \cdot {L}_{V} \cdot sin ( \cdot {θ}_{r} )}{2} & \frac{3 \cdot {L}_{V} \cdot cos ( 2 \cdot {θ}_{r} )}{2} & 0 \\ 0 & 0 & 0\end{matrix} ]$$

$${L}_{V} αβ = \frac{3 \cdot {L}_{V}}{2} \cdot [ \begin{matrix}- cos ( 2 \cdot {θ}_{r} ) & sin ( 2 \cdot {θ}_{r} ) & 0 \\ sin ( 2 \cdot {θ}_{r} ) & cos ( 2 \cdot {θ}_{r} ) & 0 \\ 0 & 0 & 0\end{matrix} ]$$

Transforming into the electrical reference frame:

$${L}_{VQdr} = {K}_{3 \times 3} ( {θ}_{r} ) \cdot {L}_{V αβ} \cdot {{K}_{3 \times 3} ( {θ}_{r} )}^{- 1}$$

$${L}_{VQdr} = \frac{3 \cdot {L}_{V}}{2} \cdot [ \begin{matrix}- 1 & 0 & 0 \\ 0 & 1 & 0 \\ 0 & 0 & 0\end{matrix} ]$$

From the foregoing, the inductance in Q and d axis may be expressed as:

L_{Qdr}=Constant component+angle dependant component

### That is:

$${L}_{Qdr} = [ \begin{matrix}{L}_{Qr} & 0 \\ 0 & {L}_{dr}\end{matrix} ] = [ \begin{matrix}L + M & 0 \\ 0 & L + M\end{matrix} ] + [ \begin{matrix}- \frac{3 \cdot {L}_{V}}{2} & 0 \\ 0 & \frac{3 \cdot {L}_{V}}{2}\end{matrix} ]$$

$${L}_{Qr} = ( L + M ) - \frac{3 \cdot {L}_{V}}{2}$$

$${L}_{dr} = ( L + M ) + \frac{3 \cdot {L}_{V}}{2}$$

The abc reference frame flux linkage may be expressed as:

λ_{abc}

The αβ flux linkage may be expressed as:

$${λ}_{αβ 0} = [ \begin{matrix}{λ}_{α} \\ {λ}_{β} \\ {λ}_{0}\end{matrix} ] = C \cdot {λ}_{abc}$$

The Qdr frame of reference flux linkage may be expressed as:

$${λ}_{Qdr} = [ \begin{matrix}{λ}_{Qdr} \\ {λ}_{dr} \\ {λ}_{0}\end{matrix} ] = K ( {θ}_{r} ) \cdot {λ}_{αβ 0}$$

Magnet flux in the terminal frame of reference may be expressed as:

$${λ}_{fabc} = {λ}_{f} \cdot [ \begin{matrix}sin ( {θ}_{r} ) \\ sin ( {θ}_{r} - 2 \cdot π \text{/} 3 ) \\ sin ( {θ}_{r} + 2 \cdot π \text{/} 3 )\end{matrix} ]$$

Magnet flux in the electrical frame of reference may be expressed as:

$${λ}_{fQdr} = [ \begin{matrix}{λ}_{fQr} \\ {λ}_{fdr}\end{matrix} ]$$

Then, calculating the explicit values:

λ_{fQdr}=K(θᵣ)·α_{αβ0}

λ_{fQdr}=K(θᵣ)·α_{αβ0}

λ_{fQdr}=λ_{f}·U_{y}

The derivative of magnet flux in the αβ frame of reference may be expressed as:

$$\frac{d {λ}_{f αβ}}{d t} = {ω}_{r} \cdot G \cdot {λ}_{f αβ}$$

With regard to diagnostic signals and their associated reference frame, after defining a nominal diagnostic frequency ω_{d} the associated diagnostic angle at time T may be expressed as:

$${θ}_{d} = {\int }_{0}^{T} {ω}_{0} d t$$

The rotating reference frame position may be expressed as the angle θ_{d}. Later diagnostic signals may be considered. These may typically be voltages defined in an appropriate manner for direct addition to the control signal being presented to the inverter. They may be a scalar multiple of the two by one vector:

$$[ \begin{matrix}sin ( {θ}_{d} ) \\ cos ( {θ}_{d} )\end{matrix} ]$$

Variables in a rotating reference frame may be transformed to another reference frame via the αβ stationary reference frame. For example, a variable in the electrical reference frame X_{Qdr} may be transformed to X_{Qdd} by:

X_{Qdd}=K(θ_{d})·K⁻¹(θᵣ)·X_{Qdr}

This may be simplified to:

X_{Qdd}=K(θ_{d}−θᵣ)·X_{Qdr}

An identity may be expressed as:

K_{δ}=K(θ_{d}−θᵣ)

The machine state equations may be derived in the diagnostic reference using the electrical reference frame equations as the starting point.

The electrical equation may be expressed as:

$${V}_{Qdr} = {R}_{Qdr} \cdot {I}_{Qdr} + \frac{d {λ}_{Qdr}}{d t}$$

The flux equation may be expressed as:

λ_{Qdr}=λ_{fQdr}+L_{Qdr}·I_{Qdr}

λ_{Qdr}=λ_{f}·U_{y}+L_{Qdr}·I_{Qdr}

The flux equation may be substituted into the electrical equation and the result simplified as:

$${V}_{Qdr} = {R}_{Qdr} \cdot {I}_{Qdr} + {ω}_{r} \cdot G \cdot {λ}_{fQdr} + {L}_{Qdr} \cdot \frac{d {I}_{Qdr}}{d t} + {ω}_{r} \cdot G \cdot {L}_{Qdr} \cdot {I}_{Qdr}$$

The equation for magnet flux in the αβ frame of reference may be expressed as:

$$\frac{d {λ}_{f αβ}}{d t} = {ω}_{r} \cdot G \cdot {λ}_{f αβ}$$

The state variables may be transformed into the diagnostic reference frame:

$$\frac{d ( {K}_{d}^{- 1} \cdot {λ}_{fQdd} )}{d t} = {ω}_{r} \cdot G \cdot {K}_{d}^{- 1} \cdot {λ}_{fQdd}$$

Expanding and simplifying this equation yields the expression:

$$\frac{d ( {λ}_{fQdd} )}{d t} = ( {ω}_{r} - {ω}_{d} ) \cdot {λ}_{fQdd}$$

In the abc or terminal frame of reference:

total flux linkage=flux from constant inductance+flux from angle varying inductance+magnet flux

In the electrical frame of reference this may be expressed as

λ_{Qdr}=L_{Qdr}·I_{Qdr}λ_{fQdr}

Solving for current may yield the expression:

I_{Qdr}=L_{Qdr}⁻¹·(λ_{Qdr}−λ_{fQdr})

Transforming to the diagnostic reference frame, indicated by Qdd in the subscript, may yield the expression:

I_{Qdd}=K_{δ}·L_{Qdr}⁻¹·K_{δ}⁻¹·(λ_{Qdd}−λ_{fQdd})

### Wherein:

$${K}_{δ} \cdot {L}_{Qdr}^{- 1} \cdot {K}_{δ}^{- 1} = [ \begin{matrix}\frac{{L}_{Qr} - {L}_{Qr} \cdot {cos ( {θ}_{r} - {θ}_{d} )}^{2} + {L}_{dr} \cdot {cos ( {θ}_{r} - {θ}_{d} )}^{2}}{{L}_{Qr} \cdot {L}_{dr}} & \frac{sin ( 2 \cdot {θ}_{r} - 2 \cdot {θ}_{d} ) \cdot ( {L}_{Qr} - {L}_{dr} )}{2 \cdot {L}_{Qr} \cdot {L}_{dr}} \\ \frac{sin ( 2 \cdot {θ}_{r} - 2 \cdot {θ}_{d} ) \cdot ( {L}_{Qr} - {L}_{dr} )}{2 \cdot {L}_{Qr} \cdot {L}_{dr}} & \frac{{L}_{dr} + {L}_{Qr} \cdot {cos ( {θ}_{r} - {θ}_{d} )}^{2} - {L}_{dr} \cdot {cos ( {θ}_{r} - {θ}_{d} )}^{2}}{{L}_{Qr} \cdot {L}_{dr}}\end{matrix} ]$$

If the Q and d axis inductances in the electrical frame are equal here is no angle varying inductance), then this equation may be simplified to:

$${K}_{δ} \cdot {L}_{Qdr}^{- 1} \cdot {K}_{δ}^{- 1} = [ \begin{matrix}\frac{1}{L + M} & 0 \\ 0 & \frac{1}{L + M}\end{matrix} ]$$

The voltage equation in the electrical frame of reference may be expressed as:

$${V}_{Qdr} = {R}_{Qdr} \cdot {I}_{Qdr} + \frac{d {λ}_{Qdr}}{d t}$$

This may be transformed to the diagnostic reference frame to yield:

$${V}_{Qdd} = {K}_{δ} \cdot {R}_{Qdr} \cdot {K}_{δ}^{- 1} \cdot {I}_{Qdd} + {K}_{δ} \cdot \frac{d ( {K}_{δ}^{- 1} \cdot {λ}_{Qdd} )}{d t}$$

Substituting the expression for current derived above, simplifying, and making use of the transform properties may result in the expression:

$${V}_{Qdd} = {R}_{Qdr} \cdot {K}_{δ} \cdot {L}_{Qdr}^{- 1} \cdot {K}_{δ}^{- 1} \cdot ( {λ}_{Qdd} - {λ}_{fQdd} ) + {ω}_{δ} \cdot G \cdot {λ}_{Qdd} + \frac{d {λ}_{Qdd}}{d t}$$

Two identities may be introduced N and M where:

$$P + Q = {R}_{Qdr} \cdot {K}_{δ} \cdot {L}_{Qdr}^{- 1} \cdot {K}_{δ}^{- 1}$$

$$And$$

$$P = [ \begin{matrix}\frac{4 \cdot {R}_{Qdr} \cdot ( L + M )}{9 \cdot {L}_{V}^{2} - 4 \cdot {( L + M )}^{2}} & 0 \\ 0 & \frac{4 \cdot {R}_{Qdr} \cdot ( L + M )}{9 \cdot {L}_{V}^{2} - 4 \cdot {( L + M )}^{2}}\end{matrix} ]$$

$$Q = [ \begin{matrix}\frac{6 \cdot {L}_{V} \cdot {R}_{Qdr} \cdot cos ( 2 \cdot {θ}_{r} - 2 \cdot {θ}_{d} )}{9 \cdot {L}_{V}^{2} - 4 \cdot {( L + M )}^{2}} & - \frac{6 \cdot {L}_{V} \cdot {R}_{Qdr} \cdot sin ( 2 \cdot {θ}_{r} - 2 \cdot {θ}_{d} )}{9 \cdot {L}_{V}^{2} - 4 \cdot {( L + M )}^{2}} \\ - \frac{6 \cdot {L}_{V} \cdot {R}_{Qdr} \cdot sin ( 2 \cdot {θ}_{r} - 2 \cdot {θ}_{d} )}{9 \cdot {L}_{V}^{2} - 4 \cdot {( L + M )}^{2}} & - \frac{6 \cdot {L}_{V} \cdot {R}_{Qdr} \cdot cos ( 2 \cdot {θ}_{r} - 2 \cdot {θ}_{d} )}{9 \cdot {L}_{V}^{2} - 4 \cdot {( L + M )}^{2}}\end{matrix} ]$$

When there is no angle varying inductance, these may be simplified to:

$$P = [ \begin{matrix}\frac{{R}_{Qdr}}{L + M} & 0 \\ 0 & \frac{{R}_{Qdr}}{L + M}\end{matrix} ]$$

$$Q = [ \begin{matrix}0 & 0 \\ 0 & 0\end{matrix} ]$$

The voltage equation may then be expressed as:

$${V}_{Qdd} = P \cdot {λ}_{Qdd} + Q \cdot {λ}_{Qdd} - P \cdot {λ}_{fQdd} - Q \cdot {λ}_{fQdd} + {ω}_{δ} \cdot G \cdot {λ}_{Qdd} + \frac{d {λ}_{Qdd}}{d t}$$

For the magnet flux:

$$Q \cdot {λ}_{fQdd} = \frac{6 \cdot {L}_{V} \cdot {R}_{Qdr}}{9 \cdot {L}_{V}^{2} - 4 \cdot {( L + M )}^{2}} \cdot {λ}_{fQdd}$$

Collecting terms may yield the expression:

$${V}_{Qdd} = ( P + {ω}_{δ} \cdot G ) \cdot {λ}_{Qdd} + Q \cdot {λ}_{Qdd} - \frac{2 \cdot {R}_{Qdr}}{2 \cdot ( L + M ) + {L}_{V}} \cdot {λ}_{fQdd} + \frac{d {λ}_{Qdd}}{d t}$$

This equation may be expressed as:

$$\frac{d {λ}_{Qdd}}{d t} = - ( P + {ω}_{δ} \cdot G ) \cdot {λ}_{Qdd} - Q \cdot {λ}_{Qdd} + \frac{2 \cdot {R}_{Qdr}}{2 \cdot ( L + M ) + {L}_{V}} \cdot {λ}_{fQdd} + {V}_{Qdd}$$

The final step may be to deal with the varying angle component Q·λ_{Qdd} in the previous equation. In the diagnostic reference frame there may be several different ways in which this may be dealt with. One way may be to assume that this is a slowly varying component with respect to the dynamics of the filter, and two auxiliary states are defined where:

λ_{Aux}=Q·λ_{Qdd}

Then it may be shown that:

$$\frac{d {λ}_{Aux}}{d t} = 2 \cdot ( {ω}_{r} - {ω}_{d} ) \cdot G \cdot {λ}_{Aux}$$

This formulation implies a filter with a six by one state vector.

Exemplary mathematical expressions regarding implementation of the Kalman filter may be as follows.

Collecting together:

$$\frac{d {λ}_{Qdd}}{d t} = - ( P + {ω}_{δ} \cdot G ) \cdot {λ}_{Qdd} - {λ}_{Aux} + \frac{2 \cdot {R}_{Qdr}}{2 \cdot ( L + M ) + {L}_{V}} \cdot {λ}_{fQdd} + {V}_{Qdd}$$

$$\frac{d ( {λ}_{fQdd} )}{d t} = ( {ω}_{r} - {ω}_{d} ) \cdot {λ}_{fQdd}$$

$$\frac{d {λ}_{Aux}}{d t} = 2 \cdot ( {ω}_{r} - {ω}_{d} ) \cdot G \cdot {λ}_{Aux}$$

### Originally:

I_{Qdd}=K_{δ}·L_{Qdr}⁻¹·K_{δ}⁻¹·(λ_{Qdd}−λ_{fQdd})

### And:

P+Q=R_{Qdr}·K_{δ}·L_{Qdr}⁻¹·K_{δ}⁻¹

After substitution, this may yield the expression:

I_{Qdd}=P·(λ_{Qdd}−λ_{fQdd})+Q·λ_{Qdd}−Q·λ_{fQdd}

Noting expressions previously defined and derived, it may be that:

$${I}_{Qdd} = \frac{4 \cdot {R}_{Qdr} \cdot ( L + M )}{9 \cdot {L}_{V}^{2} - 4 \cdot {( L + M )}^{2}} \cdot ( {λ}_{Qdd} - {λ}_{fQdd} ) + {λ}_{Aux} - \frac{6 \cdot {R}_{Qdr} \cdot {L}_{V}}{9 \cdot {L}_{V}^{2} - 4 \cdot {( L + M )}^{2}} \cdot {λ}_{fQdd}$$

By definition:

$${λ}_{Aux} = [ \begin{matrix}\frac{6 \cdot {L}_{V} \cdot {R}_{Qdr} \cdot {λ}_{Qd} \cdot cos ( δ )}{4 \cdot {( L + M )}^{2} - 9 \cdot {L}_{V}^{2}} - \frac{6 \cdot {L}_{V} \cdot {R}_{Qdr} \cdot {λ}_{dd} \cdot sin ( δ )}{4 \cdot {( L + M )}^{2} - 9 \cdot {L}_{V}^{2}} \\ \frac{6 \cdot {L}_{V} \cdot {R}_{Qdr} \cdot {λ}_{dd} \cdot cos ( δ )}{4 \cdot {( L + M )}^{2} - 9 \cdot {L}_{V}^{2}} - \frac{6 \cdot {L}_{V} \cdot {R}_{Qdr} \cdot {λ}_{Qd} \cdot sin ( δ )}{4 \cdot {( L + M )}^{2} - 9 \cdot {L}_{V}^{2}}\end{matrix} ]$$

### That is:

$$\frac{4 \cdot {( L + M )}^{2} - 9 \cdot {L}_{V}^{2}}{6 \cdot {L}_{V} \cdot {R}_{Qdr}} \cdot {λ}_{Aux} = [ \begin{matrix}- cos ( δ ) & sin ( δ ) \\ sin ( δ ) & cos ( δ )\end{matrix} ]$$

Taking the Moore-Penrose pseudo inverse and introducing the identity A may yield the expression:

$$A = [ \begin{matrix}- cos ( δ ) & sin ( δ ) \\ sin ( δ ) & cos ( δ )\end{matrix} ] = \frac{4 \cdot {( L + M )}^{2} - 9 \cdot {L}_{V}^{2}}{6 \cdot {L}_{V} \cdot {R}_{Qdr}} \cdot {λ}_{Aux} \cdot {( {λ}_{Qdd}^{T} \cdot {λ}_{Qdd} )}^{- 1} \cdot {λ}_{Qdd}^{T}$$

From this, two separate estimates of electrical angle may be available, using the four quadrant arctangent function may yield the expressions:

tan 2⁻¹(A_{2,1},−A_{1,1})

tan 2⁻¹(A_{2,2},A_{2,1})

Electrical speed may then be determined as in the high speed sensorless method by numerical differentiation of estimated electrical angle followed by a low pass filter to isolate electrical angle and filter dynamics.

Although the invention has been described with reference to the one or more embodiments illustrated in the figures, it is understood that equivalents may be employed and substitutions made herein without departing from the scope of the invention as recited in the claims.

Having thus described one or more embodiments of the invention, what is claimed as new and desired to be protected by Letters Patent includes the following:

1. A system for determining an electrical angle of an electric motor operating at a zero or low speed, wherein the electric motor is characterized by one or more state equations, the system comprising:
the electric motor;
an inverter configured to drive the electric motor with a control signal; and
a control element configured to—
inject a high frequency voltage demand into the control signal,
read a motor current and a motor voltage in a stationary reference frame,
transform the motor current and the motor voltage into a diagnostic reference frame,
determine a bulk current model for a motor inductance and a motor resistance,
update the one or more state equations using a Kalman filter, and
determine the electrical angle using the updated one or more state equations.

2. The system as set forth in claim 1, wherein the electric motor is a three phase, balanced fed permanent magnet electric motor that drives a load.

3. The system as set forth in claim 2, wherein the load is selected from the group consisting of: fans, pumps, blowers, rotating drums, components of clothes washers or clothes dryers, components of ovens, components of heating and air-conditioning units, and components of residential or commercial machines.

4. The system as set forth in claim 1, wherein the electric motor is operating at a speed that is equal to or less than approximately between 200 and 300 mechanical revolutions per minute.

5. The system as set forth in claim 1, wherein the stationary reference frame is an abc reference frame or an alpha-beta reference frame.

6. The system as set forth in claim 1, wherein the Kalman filter is a linear Kalman filter.

7. The system as set forth in claim 1, wherein the Kalman filter is a Luenberger observer.

8. The system as set forth in claim 1, further including the steps of—
estimating an electrical speed of the electric motor as a differential of the electrical angle; and
filtering the electrical speed using a first order filter.

9. A system for determining an electrical angle of an electric motor operating at a speed that is equal to or less than approximately between 200 and 300 mechanical revolutions per minute, wherein the electric motor is a three phase, balanced fed permanent magnet electric motor that is driven by an inverter and that drives a load, and wherein the electric motor is characterized by one or more state equations, the system comprising:
the electric motor;
an inverter configured to drive the electric motor with a control signal; and
a control element configured to—
inject a high frequency voltage demand into a control signal for the inverter,
read a motor current and a motor voltage in a stationary reference frame,
transform the motor current and the motor voltage into a diagnostic reference frame,
determine a bulk current model for a motor inductance and a motor resistance,
update the one or more state equations using a Kalman filter,
determine the electrical angle using the updated one or more state equations,
estimate an electrical speed of the electric motor as a differential of the electrical angle, and
filter the electrical speed using a first order filter.

10. The system as set forth in claim 9, wherein the load is selected from the group consisting of: fans, pumps, blowers, rotating drums, components of clothes washers or clothes dryers, components of ovens, components of heating and air-conditioning units, and components of residential or commercial machines.

11. The system as set forth in claim 9, wherein the stationary reference frame is an abc reference frame or an alpha-beta reference frame.

12. The system as set forth in claim 9, wherein the Kalman filter is a linear Kalman filter.

13. The system as set forth in claim 9, wherein the Kalman filter is a Luenberger observer.

14. A method for determining an electrical angle of an electric motor operating at a zero or low speed, wherein the electric motor is driven by an inverter and characterized by one or more state equations, the method comprising the steps of:
injecting a high frequency voltage demand into a control signal produced by the inverter;
reading a motor current and a motor voltage in a stationary reference frame;
transforming the motor current and the motor voltage into a diagnostic reference frame;
determining a bulk current model for a motor inductance and a motor resistance;
updating the one or more state equations using a Kalman filter; and
determining the electrical angle using the updated one or more state equations.

15. The method as set forth in claim 14, wherein the electric motor is a three phase, balanced fed permanent magnet electric motor that drives a load.

16. The method as set forth in claim 15, wherein the load is selected from the group consisting of: fans, pumps, blowers, rotating drums, components of clothes washers or clothes dryers, components of ovens, components of heating and air-conditioning units, and components of residential or commercial machines.

17. The method as set forth in claim 14, wherein the electric motor is operating at a speed that is equal to or less than approximately between 200 and 300 mechanical revolutions per minute.

18. The method as set forth in claim 14, wherein the stationary reference frame is an abc reference frame or an alpha-beta reference frame.

19. The method as set forth in claim 14, wherein the Kalman filter is a linear Kalman filter.

20. The method as set forth in claim 14, wherein the Kalman filter is a Luenberger observer.

21. The method as set forth in claim 14, further including the steps of—
estimating an electrical speed of the electric motor as a differential of the electrical angle; and
filtering the electrical speed using a first order filter.

22. A method for determining an electrical angle of an electric motor operating at a speed that is equal to or less than approximately between 200 and 300 mechanical revolutions per minute, wherein the electric motor is a three phase, balanced fed permanent magnet electric motor that is driven by an inverter and that drives a load, and wherein the electric motor is characterized by one or more state equations, the method comprising the steps of:
injecting a high frequency voltage demand into a control signal produced by the inverter;
reading a motor current and a motor voltage in a stationary reference frame;
transforming the motor current and the motor voltage into a diagnostic reference frame;
determining a bulk current model for a motor inductance and a motor resistance;
updating the one or more state equations using a Kalman filter;
determining the electrical angle using the updated one or more state equations;
estimating an electrical speed of the electric motor as a differential of the electrical angle; and
filtering the electrical speed using a first order filter.

23. The method as set forth in claim 22, wherein the load is selected from the group consisting of: fans, pumps, blowers, rotating drums, components of clothes washers or clothes dryers, components of ovens, components of heating and air-conditioning units, and components of residential or commercial machines.

24. The method as set forth in claim 22, wherein the stationary reference frame is an abc reference frame or an alpha-beta reference frame.

25. The method as set forth in claim 22, wherein the Kalman filter is a linear Kalman filter.

26. The method as set forth in claim 22, wherein the Kalman filter is a Luenberger observer.
